(19) United States
(12) Patent Application Publication
(10) Pub. No.: US 2026/0352280 A1
(43) Pub. Date: Nov. 5, 2026

(54) TRANSMITTING CHANNEL STATE INFORMATION ACCORDING TO A PRIORITY OF A RECONFIGURABLE INTELLIGENT SURFACE

(71) Applicant: QUALCOMM Incorporated, San Diego, CA (US)

(72) Inventors: Ahmed ELSHAFIE, San Diego, CA (US); Wanshi CHEN, San Diego, CA (US); Zhikun WU, Beijing (CN); Yu ZHANG, San Diego, CA (US); Hung Dinh LY, San Diego, CA (US)

(21) Appl. No.: 19/100,098

(22) PCT Filed: Sep. 29, 2022
(86) PCT No.: PCT/CN2022/122394

§ 371 Date: Jan. 30, 2025

(51) Int. Cl. H04B 7/06; H04B 7/04

(52) U.S. Cl. CPC H04B 7/0626; H04B 7/04013

(57) ABSTRACT

Various aspects of the present disclosure generally relate to wireless communication. In some aspects, a user equipment (UE) may receive, from a network node or a controlling UE, an indication of a priority for one or more reconfigurable intelligent surfaces (RISs) between the UE and the network node, and for one or more sub-RISs of the one or more RISs. The UE may prepare a channel state information (CSI) report for the one or more RISs and for the one or more sub-RISs based at least in part on the indication of the priority. The UE may transmit, to the network node, the CSI report. Numerous other aspects are described.

### FIELD OF THE DISCLOSURE

Aspects of the present disclosure generally relate to wireless communication and to techniques and apparatuses for transmitting channel state information (CSI) according to a priority of a reconfigurable intelligent surface (RIS).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, a user equipment (UE) includes a memory and one or more processors, coupled to the memory, configured to: receive, from a network node or a controlling UE, an indication of a priority for one or more reconfigurable intelligent surfaces (RISs) between the UE and the network node, and for one or more sub-RISs of the one or more RISs; prepare a channel state information (CSI) report for the one or more RISs and for the one or more sub-RISs based at least in part on the indication of the priority; and transmit, to the network node, the CSI report.

In some implementations, a network node includes a memory and one or more processors, coupled to the memory, configured to: transmit, to a UE, an indication of a priority for one or more RISs between the UE and the network node, and for one or more sub-RISs of the one or more RISs; and receive, from the UE, a CSI report for the one or RISs and for the one or more sub-RISs, wherein the CSI report is prepared based at least in part on the indication of the priority.

In some implementations, a method of wireless communication performed by a UE includes receiving, from a network node or a controlling UE, an indication of a priority for one or more RISs between the UE and the network node, and for one or more sub-RISs of the one or more RISs; preparing a CSI report for the one or more RISs and for the one or more sub-RISs based at least in part on the indication of the priority; and transmitting, to the network node, the CSI report.

In some implementations, a method of wireless communication performed by a network node includes transmitting, to a UE, an indication of a priority for one or more RISs between the UE and the network node, and for one or more sub-RISs of the one or more RISs; and receiving, from the UE, a CSI report for the one or RISs and for the one or more sub-RISs, wherein the CSI report is prepared based at least in part on the indication of the priority.

In some implementations, a non-transitory computer-readable medium storing a set of instructions for wireless communication includes one or more instructions that, when executed by one or more processors of a UE, cause the UE to: receive, from a network node or a controlling UE, an indication of a priority for one or more RISs between the UE and the network node, and for one or more sub-RISs of the one or more RISs; prepare a CSI report for the one or more RISs and for the one or more sub-RISs based at least in part on the indication of the priority; and transmit, to the network node, the CSI report.

In some implementations, a non-transitory computer-readable medium storing a set of instructions for wireless communication includes one or more instructions that, when executed by one or more processors of a network node, cause the network node to: transmit, to a UE, an indication of a priority for one or more RISs between the UE and the network node, and for one or more sub-RISs of the one or more RISs; and receive, from the UE, a CSI report for the one or RISs and for the one or more sub-RISs, wherein the CSI report is prepared based at least in part on the indication of the priority.

In some implementations, an apparatus for wireless communication includes means for receiving, from a network node or a controlling UE, an indication of a priority for one or more RISs between the apparatus and the network node, and for one or more sub-RISs of the one or more RISs; means for preparing a CSI report for the one or more RISs and for the one or more sub-RISs based at least in part on the indication of the priority; and means for transmitting, to the network node, the CSI report.

In some implementations, an apparatus for wireless communication includes means for transmitting, to a UE, an indication of a priority for one or more RISs between the UE and the apparatus, and for one or more sub-RISs of the one or more RISs; and means for receiving, from the UE, a CSI report for the one or RISs and for the one or more sub-RISs, wherein the CSI report is prepared based at least in part on the indication of the priority.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a reconfigurable intelligent surface (RIS), in accordance with the present disclosure.

FIG. 5 is a diagram illustrating an example of a reference signal based precoder selection, in accordance with the present disclosure.

FIG. 6 is a diagram illustrating an example of a partial channel state information (CSI) omission, in accordance with the present disclosure.

FIGS. 7-11 are diagrams illustrating examples associated with transmitting CSI according to a priority of a RIS, in accordance with the present disclosure.

FIGS. 12-13 are diagrams illustrating example processes associated with transmitting CSI according to a priority of a RIS, in accordance with the present disclosure.

FIGS. 14-15 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

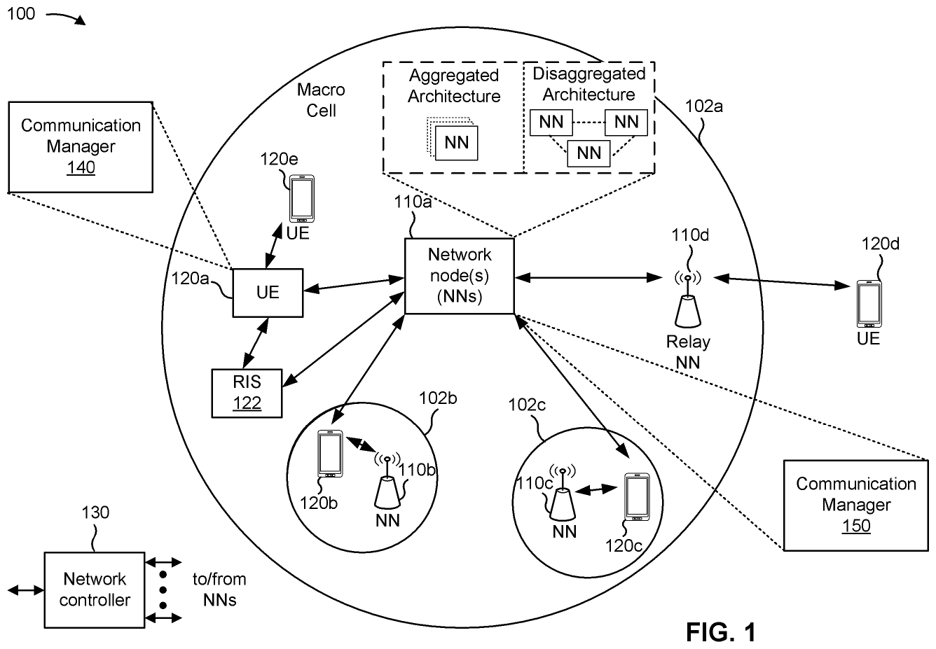

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a network node or a controlling UE, an indication of a priority for one or more reconfigurable intelligent surfaces (RISs) between the UE and the network node, and for one or more sub-RISs of the one or more RISs; prepare a channel state information (CSI) report for the one or more RISs and for the one or more sub-RISs based at least in part on the indication of the priority; and transmit, to the network node, the CSI report. Additionally, or alternatively, the communication manager 140 may perform one or more other operations described herein.

In some aspects, a network node (e.g., network node 110) may include a communication manager 150. As described in more detail elsewhere herein, the communication manager 150 may transmit, to a UE, an indication of a priority for one or more RISs between the UE and the network node, and for one or more sub-RISs of the one or more RISs; and receive, from the UE, a CSI report for the one or RISs and for the one or more sub-RISs, wherein the CSI report is prepared based at least in part on the indication of the priority. Additionally, or alternatively, the communication manager 150 may perform one or more other operations described herein.

As indicated above, FIG. 1 is provided as an example. Other examples may differ from what is described with regard to FIG. 1.

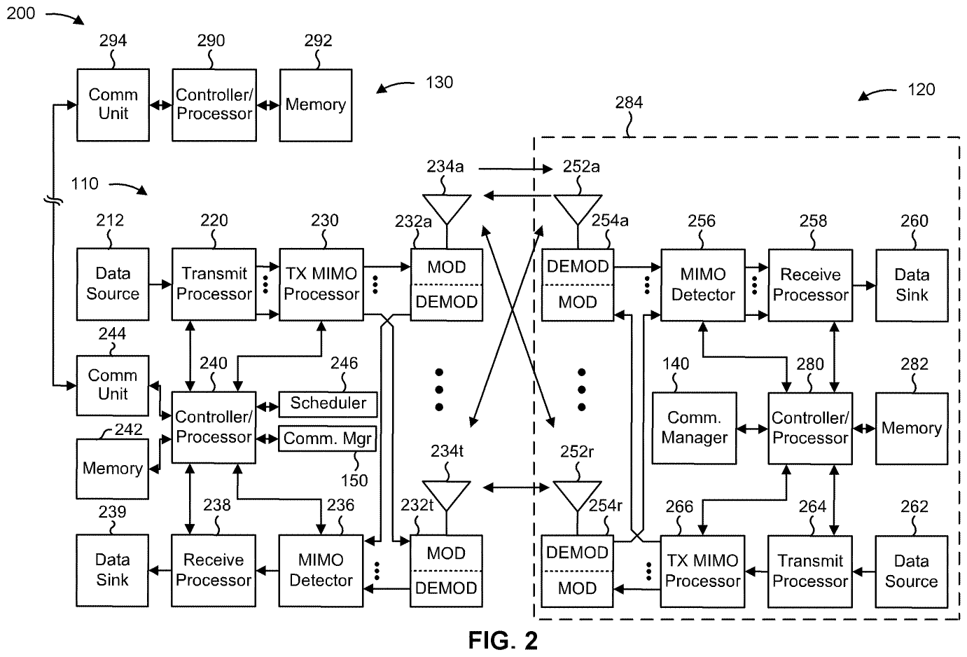

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

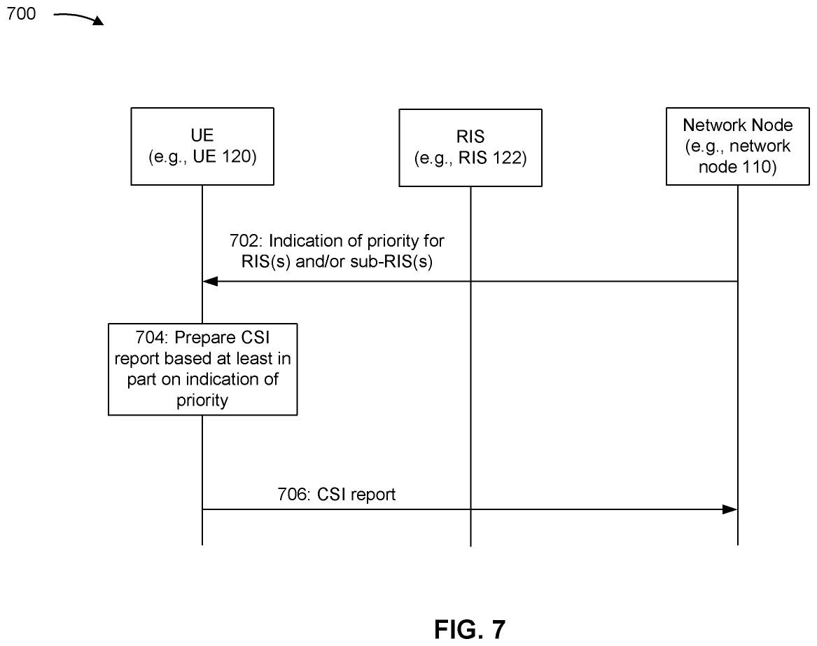

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-15).

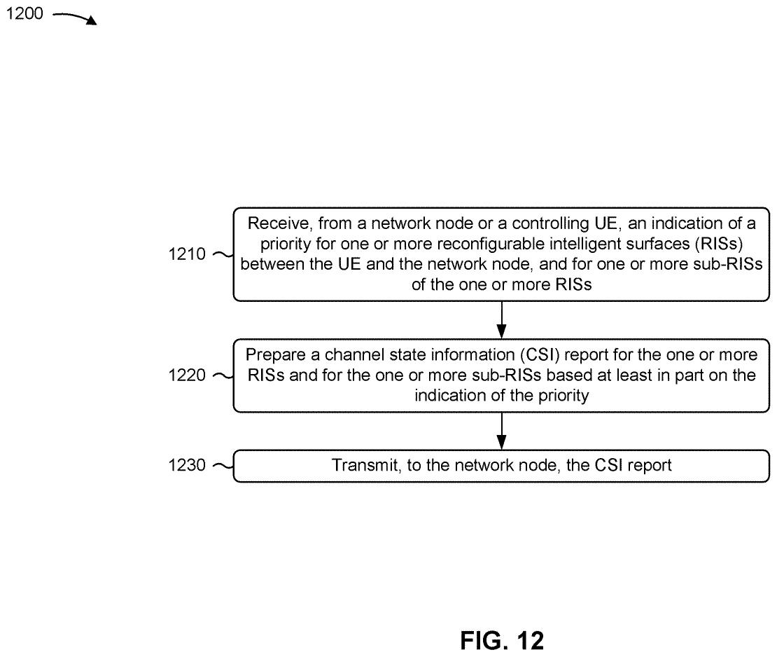

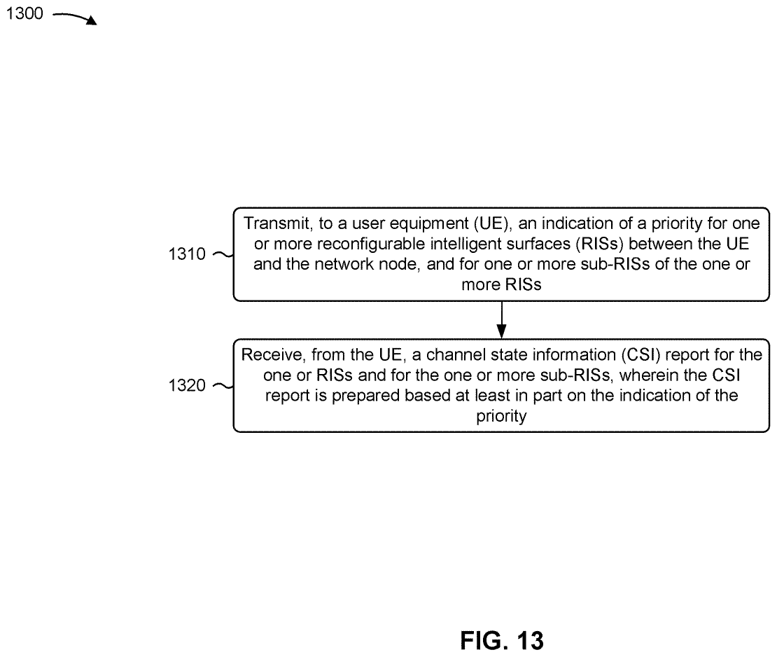

The controller/processor 240 of the network node 110, the controller/processor 280 of the UE 120, and/or any other component(s) of FIG. 2 may perform one or more techniques associated with transmitting CSI according to a priority of a RIS, as described in more detail elsewhere herein. For example, the controller/processor 240 of the network node 110, the controller/processor 280 of the UE 120, and/or any other component(s) of FIG. 2 may perform or direct operations of, for example, process 1200 of FIG. 12, process 1300 of FIG. 13, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from a network node or a controlling UE, an indication of a priority for one or more RISs between the UE and the network node, and for one or more sub-RISs of the one or more RISs; means for preparing a CSI report for the one or more RISs and for the one or more sub-RISs based at least in part on the indication of the priority; and/or means for transmitting, to the network node, the CSI report. In some aspects, the means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., network node 110) includes means for transmitting, to a UE, an indication of a priority for one or more RISs between the UE and the network node, and for one or more sub-RISs of the one or more RISs; and/or means for receiving, from the UE, a CSI report for the one or RISs and for the one or more sub-RISs, wherein the CSI report is prepared based at least in part on the indication of the priority. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

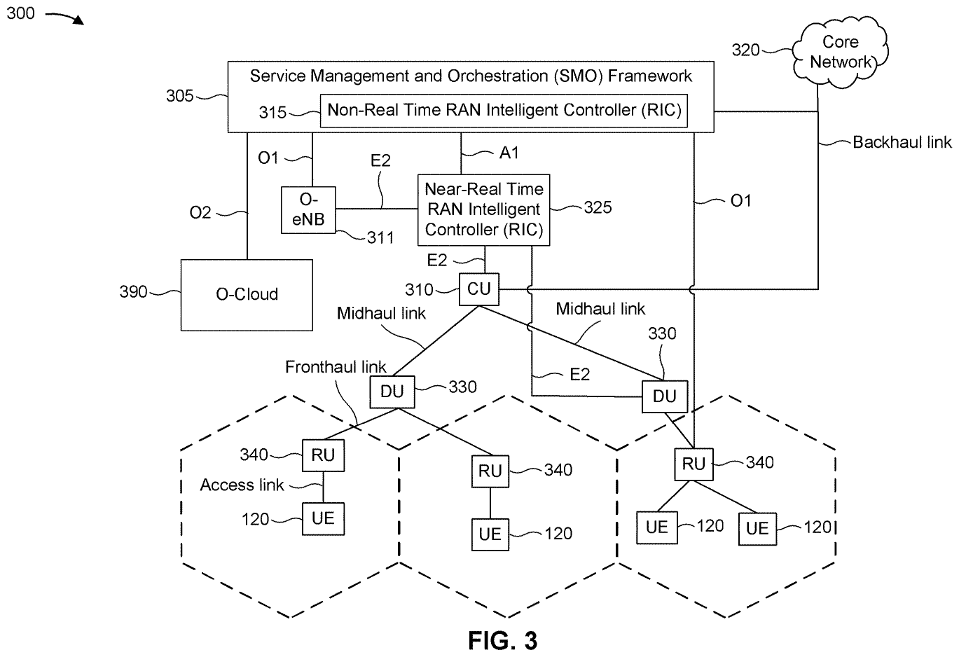

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

Massive MIMO may achieve increased throughput in an NR system. Massive MIMO may achieve high beamforming gain by using active antenna units. Massive MIMO may involve individual RF chains per antenna port. The high beamforming gain and/or the individual RF chains per antenna port may in part result in the increased throughput. With massive MIMO, a significant increase in power consumption may occur due to the use of active antenna units (AAUs).

RISs are network elements that are employed to extend NR coverage with negligible power consumption. An RIS may be a mirror-like near passive device. The RIS may include X elements in a horizontal direction and Y elements in a vertical direction. In other words, the RIS may be comprised of X by Y elements. Each element may reflect a waveform that is incident to a surface of the element. The waveform may be transmitted by a network node or a UE. Each element may reflect the waveform based at least in part on a reflection coefficient, such that the waveform may be reflected to a direction. The waveform that strikes the element may be an incident waveform, and the waveform that is reflected from the element may be a reflected waveform. The direction toward which the waveform is reflected may be a function of the reflection coefficient and/or a phase associated with the element that reflects the waveform.

The direction toward which the waveform is reflected, or a reflection direction, may be controlled by the network node. For example, the network node may transmit an indication of a reflection direction to an RIS controller associated with the RIS. The indication of the reflection direction may indicate the reflection coefficient and/or phase for each element associated with the RIS. The RIS controller may adjust the reflection coefficient and/or phase for each element based at least in part on the indication received from the network node.

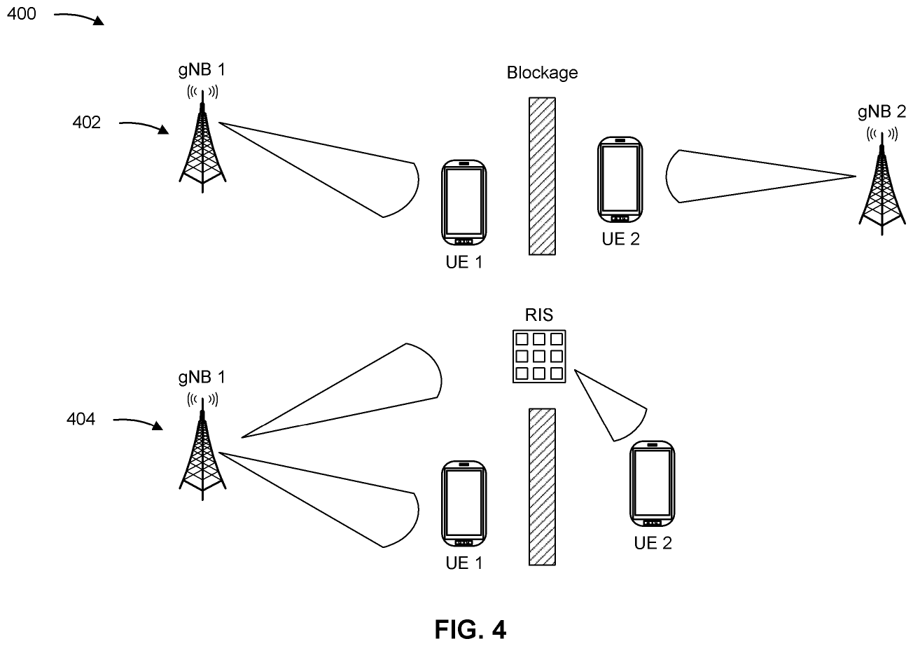

FIG. 4 is a diagram illustrating an example 400 of an RIS, in accordance with the present disclosure.

As shown by reference number 402, a first network node (gNB1) may transmit a first downlink transmission to a first UE (UE1). A second network node (gNB2) may transmit a second downlink transmission to a second UE (UE2). The first UE and the second UE may be separated by a blockage. As a result, downlink transmissions from the first network node may not be received by the second UE, and downlink transmissions from the second network node may not be received by the first UE.

As shown by reference number 404, an RIS may be employed in proximity to the blockage. The first network node may transmit a first downlink transmission to the first UE and a second downlink transmission to the RIS. The RIS may include a plurality of elements that reflect the second downlink transmission in a direction toward the second UE. As a result, the first network node may effectively perform downlink transmissions to the second UE via the RIS, even though the blockage is present between the first network node and the second UE.

As indicated above, FIG. 4 is provided as an example. Other examples may differ from what is described with regard to FIG. 4.

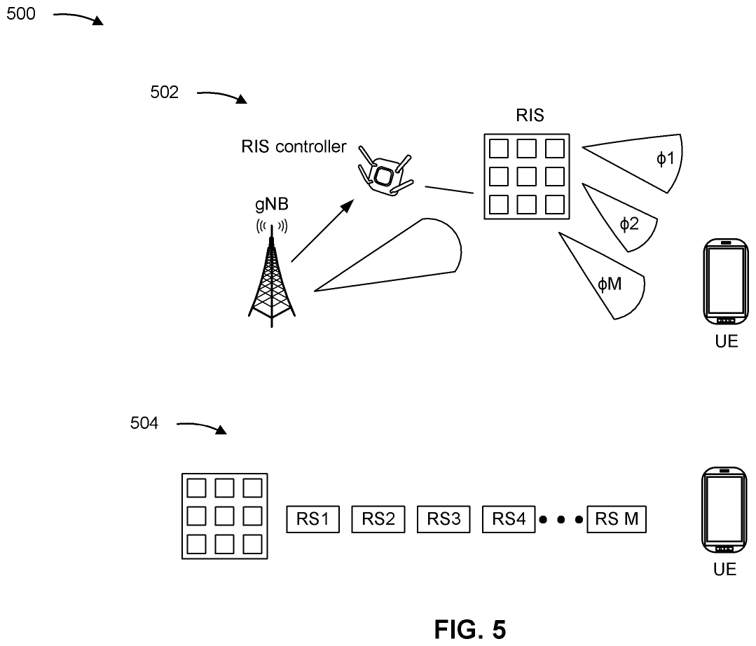

FIG. 5 is a diagram illustrating an example 500 of a reference signal based precoder selection, in accordance with the present disclosure.

As shown by reference number 502, a network node may transmit multiple reference signals (e.g., RS1, RS2, . . . RS M) in a downlink to an RIS. Each reference signal may be associated with a phase and a reference signal occasion. The multiple reference signals may be associated with M reference signal occasions. The multiple reference signals may be reflected toward multiple directions (e.g., φ1, φ2, . . . φM). As shown by reference number 504, the multiple reference signals may be reflected from the RIS and received at a UE. The RIS may use a different precoder (e.g., a codebook or a non-codebook precoder) and/or phase for each reference signal associated with each reference signal occasion.

The UE may measure a power level (e.g., an RSRP) associated with each of the multiple reference signals associated with the M reference signal occasions. The UE may identify a reference signal with a highest power level as compared to other reference signals. The UE may transmit, to the controller associated with the RIS and/or the network node, a reference signal index associated with the reference signal with the highest power level. The reference signal with the highest power level, as compared to the other reference signals, may be a reference signal with a best energy, RSRP, RSRQ, signal to interference noise ratio (SINR), channel quality indicator (CQI), and/or channel metric. The network node and/or the controller may select a precoder for a reference signal occasion associated with the reference signal with the highest power level. As a result, the network node and/or the controller may be able to determine which precoder or RIS beamformer is best for serving the UE. In some cases, the network node may transmit the multiple reference signals to the RIS in the downlink. Alternatively, the UE may transmit multiple reference signals to the RIS in an uplink.

As indicated above, FIG. 5 is provided as an example. Other examples may differ from what is described with regard to FIG. 5.

Priority and collision rules may be defined in an NR system. Two or more channel state information (CSI) reports may collide with each other, such that the two or more CSI reports may be scheduled to be transmitted simultaneously from a UE to a network node. For example, a periodic CSI report and an aperiodic CSI report may be scheduled to be transmitted at the same time. In some cases, a quantity of CSI reports scheduled to be transmitted simultaneously may result in a payload size that is too large to fit in an uplink control information (UCI) container, which may be due to a hybrid automatic repeat request acknowledgement (HARQ-ACK) and/or a scheduling request (SR) additionally needing to be multiplexed. In these situations, some CSI reports may be dropped or omitted.

A number of prioritization rules may be defined for determining which CSI reports should be dropped or omitted by the UE, and which CSI report should be transmitted to the network node. CSI reports may first be prioritized according to a corresponding time-domain behavior and physical channel, where more dynamic CSI reports may be given priority over less dynamic CSI reports, and where a physical uplink shared channel (PUSCH) may be given priority over a physical uplink control channel (PUCCH). An aperiodic CSI report may have higher priority than a semi-persistent CSI report on the PUSCH. The semi-persistent CSI report on the PUSCH may have higher priority than a semi-persistent CSI report on the PUCCH. The semi-persistent CSI report on the PUCCH may have higher priority than a periodic CSI report.

When multiple CSI reports with the same time-domain behavior and physical channel collide with each other, the CSI reports may be further prioritized depending on CSI content. Beam reports (e.g., layer 1 (L1)-RSRP reporting) may have higher priority than regular CSI reports. A CSI report may be conditioned on a serving beam, so if a beam is not correct, the CSI report may not be useful.

CSI reports may be further prioritized based at least in part on for which serving cell the CSI report corresponds (e.g., in case of a carrier aggregation operation). A CSI report corresponding to a primary cell (PCell) may have higher priority than a CSI report corresponding to secondary cells (SCells). Further, to avoid ambiguity in which CSI report is to be transmitted, the CSI reports may be prioritized based at least in part on a report configuration identifier (reportConfigID).

The prioritization rules may be applied so that only a single CSI report is transmitted in the case of a CSI report collision, with one exception being when multiple PUCCH-based CSI reports collide. In this case, the UE may be configured with a larger multi-CSI PUCCH resource, where multiple CSI reports may be multiplexed in case of the CSI report collision. The UE may transmit as many CSI reports as possible in the multi-CSI PUCCH resource as long as a maximum UCI code rate is not exceeded.

For a PUSCH-based CSI reporting, and a Type II CSI reporting in particular, a CSI payload size may vary depending on a rank indicator (RI) selection. For example, for the Type II CSI reporting, a precoding matrix indicator (PMI) payload for RI=2 is approximately twice the size of a PMI payload for RI=1. Since an RI selection is not known to a network node prior to scheduling an aperiodic CSI report on a PUSCH, the network node may allocate PUSCH resources (e.g., in a frequency domain and in a time domain) using an estimate of the RI selection. For example, the network node may allocate PUSCH resources based at least in part on historical RI reports. In some cases, the network node may allocate the PUSCH resources with the assumption that the UE will report RI=1, but the UE may actually later report RI=2. In this case, a CSI payload may not fit in a PUSCH container (e.g., a code rate may exceed a threshold or un-coded systematic bits may not fit in the PUSCH container). Instead of dropping an entire CSI report, which would be wasteful, a scheme for a partial CSI omission for PUSCH-based CSI in NR may be implemented. A portion of the CSI payload may still be reported, which may provide information regarding the RI selection so that the network node may allocate the proper PUSCH resource for the next aperiodic CSI request.

The partial CSI omission for the PUSCH-based CSI in NR may be accomplished by ordering CSI content in a particular manner. When multiple CSI reports are transmitted in the PUSCH, wideband CSI components (e.g., a wideband PMI and channel quality indicator (CQI)) for a plurality of CSI reports (e.g., all CSI reports) may be mapped to the most significant bits of the UCI. Then, a subband CSI for each CSI report may be mapped according to some priority rules, where a subband CSI for even numbered subbands may be mapped first, which may be followed by subband CSI for odd numbered subbands.

When a resulting code rate of the UCI exceeds a threshold, a portion of the least significant UCI bits may be omitted, until the code rate falls below the threshold. A subband CSI for odd numbered subbands for a CSI report may be omitted first. The network node may have a subband PMI and CQI for ever other subband in the frequency domain, which may enable the network node to interpolate the PMI/CQI between two reported subbands to try to estimate a missing PMI/CQI values for a middle subband. Such a reconstruction may provide better performance than omitting CSI for an entire chunk of consecutive subbands.

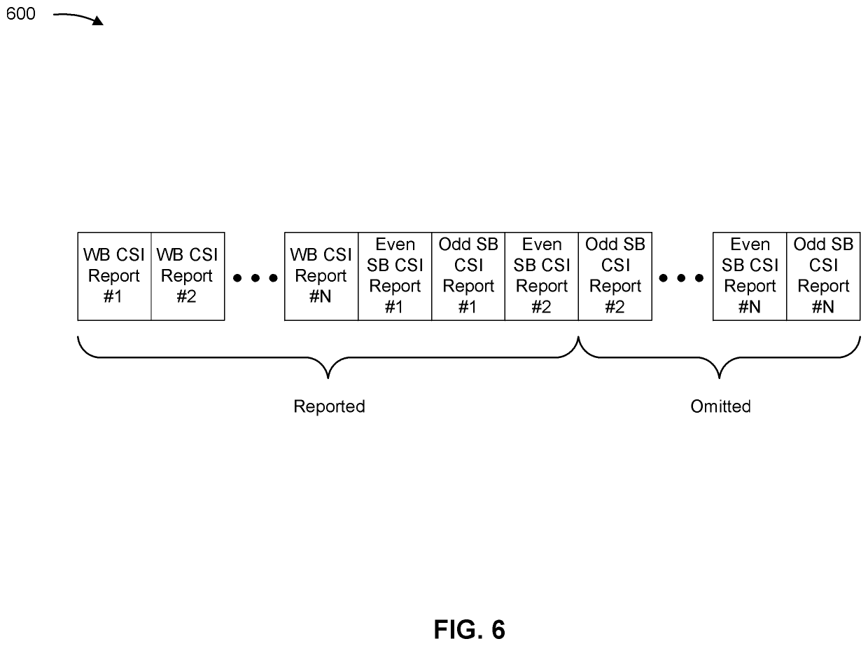

FIG. 6 is a diagram illustrating an example 600 of a partial CSI omission, in accordance with the present disclosure.

As shown in FIG. 6, wideband CSI components for a plurality of CSI reports may be mapped to the most significant bits of a UCI. A subband CSI for each CSI report may be mapped according to priority rules. A subband CSI for an even numbered subband of a CSI report may be mapped before a subband for an odd numbered subband of the CSI report. For example, the UCI may include an even subband CSI report #1, an odd subband CSI report #1, and an even subband CSI report #2. A portion of least significant CSI bits may be omitted. For example, an odd subband CSI report #2, an even subband CSI report #N, and an odd subband CSI report #N may be omitted.

As indicated above, FIG. 6 is provided as an example. Other examples may differ from what is described with regard to FIG. 6.

CSI reports may be associated with a priority value Pri_{iCSI}(y,k,c,s)=2·N_{cells}·Mₛ·y+N_{cells}·Mₛ·k+Mₛ·c+s, where y=0 for aperiodic CSI reports to be carried on a PUSCH, y=1 for semi-persistent CSI reports to be carried on a PUSCH, y=2 for semi-persistent CSI reports to be carried on a PUCCH, and y=3 for periodic CSI reports to be carried on a PUCCH. Further, k=0 for CSI reports carrying an L1-RSRP or an L1-SINR, and k=1 for CSI reports not carrying an L1-RSRP or L1-SINR. Further, c is a serving cell index, and N_{cells} is a value of a maximum number of serving cells (maxNrofServingCells) higher layer parameter. Further, s is a report configuration identifier (reportConfigID), and Mₛ is a value of a maximum number of CSI report configurations (maxNrofCSI-ReportConfigurations) higher layer parameter.

A first CSI report may have priority over a second CSI report when an associated Pri_{iCSI}(y,k,c,s) value is lower for the first CSI report than for the second CSI report. Two CSI reports may collide with each other when the time occupancy of physical channels scheduled to carry the two CSI reports overlap in at least one OFDM symbol and are transmitted on the same carrier. When a UE is configured to transmit two colliding CSI reports, and when y values are different between the two CSI reports, certain rules may be applied, except for the case when one of the y value is 2 and the other y value is 3 for CSI reports transmitted on a PUSCH or a PUCCH. According to the rules, a CSI report with a higher Pri_{iCSI}(y,k,c,s) value may not be sent by the UE. Otherwise, the two CSI reports may be multiplexed, or either CSI report may be dropped based at least in part on corresponding priority values.

A UE may be requested to measure and report CSI associated with sub-RISs (or clusters) within a RIS (one RIS). A sub-RIS may be a RIS element within the RIS. The RIS may include a plurality of sub-RISs (or a plurality of clusters or RIS elements). The sub-RIS may be serving a certain area or a group of UEs within the certain area. CSI associated with some sub-RISs may be more important than CSI associated with other sub-RISs. When a certain sub-RIS is serving a plurality of UEs, a new UE that is attempting to use that sub-RIS may be given a lower priority as compared to another sub-RIS (or RIS) that is serving a lower quantity of UEs. A higher priority RIS may be based at least in part on whether or not that RIS has active components (e.g., whether the RIS has power amplifiers on some sub-RISs). A sub-RIS within a RIS may have a higher priority than other sub-RISs within the RIS when the sub-RIS has a power amplifier and the other sub-RISs do not have power amplifiers.

A UE may measure CSI associated with multiple sub-RISs (and potentially multiple RISs) within a particular RIS. The UE may measure the CSI based at least in part on one or more reference signals received from a network node. The network node may transmit the one or more reference signals as part of a training procedure. The UE may measure the CSI for the multiple sub-RISs. The UE may need to report the CSI to the network node. However, the UE may not be configured to bundle the CSI from the multiple sub-RISs for transmission to the network node. Further, the UE may not be configured to drop certain CSI from the multiple sub-RISs when a total payload size satisfies a threshold. As a result, when attempting to bundle and transmit CSI for the multiple sub-RISs that collide with each other, some CSI which may be considered more important than other CSI may be inadvertently dropped, which may degrade a performance of the UE.

In various aspects of techniques and apparatuses described herein, a UE may receive, from a network node or a controlling UE, an indication of a priority for one or more RISs between the UE and the network node, and for one or more sub-RISs of the one or more RISs. The indication may indicate a priority for each RIS and/or for each sub-RIS of a particular RIS, of the one or more RISs. The UE may prepare a CSI report for the one or more RISs and/or the one or more sub-RISs based at least in part on the indication of the priority. The UE, when preparing the CSI report, may multiplex CSI or drop CSI associated with specific RISs of the one or more RISs and/or specific sub-RISs of the one or more sub-RISs based at least in part on the indication of the priority. The UE may transmit the CSI report to the network node. In some aspects, the UE may multiplex or drop CSI associated with RISs and/or sub-RISs based at least in part on a priority associated with each of the RISs and/or sub-RISs. As a result, the UE may transmit higher priority CSI and only drop lower priority CSI, thereby improving a performance of the UE. The UE may not inadvertently drop higher priority CSI, which would otherwise degrade the performance of the UE.

FIG. 7 is a diagram illustrating an example 700 associated with transmitting CSI according to a priority of a RIS, in accordance with the present disclosure. As shown in FIG. 7, example 700 includes communication between a UE (e.g., UE 120), a RIS (e.g., RIS 122) and a network node (e.g., network node 110). In some aspects, the UE, the RIS, and the network node may be included in a wireless network, such as wireless network 100.

As shown by reference number 702, the UE may receive, from the network node or a controlling UE, an indication of a priority for one or more RISs between the UE and the network node, and for one or more sub-RISs of the one or more RISs. The UE may receive the indication of the priority via the one or more RISs and/or the one or more sub-RISs. The UE may receive the indication of the priority for each RIS and/or sub-RIS. A sub-RIS may be a RIS element within a particular RIS. In other words, one RIS may include a plurality of sub-RISs. The UE may be capable of communicating signals to multiple RISs at a given time. Different RISs and/or sub-RISs may be associated with different priorities, depending on a relative level of importance of the RIS and/or sub-RIS. For example, a RIS that includes a power amplifier may have a higher priority than a RIS that does not include a power amplifier. Each RIS and/or sub-RIS may serve an area or a group of UEs within a certain area.

As shown by reference number 704, the UE may prepare a CSI report for the one or more RISs and for the one or more sub-RISs based at least in part on the indication of the priority. The UE, when preparing the CSI report, may multiplex CSI associated with specific RISs of the one or more RISs and/or specific sub-RISs of the one or more sub-RISs based at least in part on the indication of the priority. The UE, when preparing the CSI report, may drop CSI associated with specific RISs of the one or more RISs and/or specific sub-RISs of the one or more sub-RISs based at least in part on the indication of the priority. In other words, the UE may use the indication of the priority to determine how to multiplex/bundle/drop CSI associated with certain RISs and/or sub-RISs and prepare the CSI report.

In some aspects, the UE may receive, from the network node and during a training procedure, one or more reference signals to train the one or more RISs. The UE may receive, from the network node and during the training procedure, one or more reference signals to train the one or more sub-RISs of the one or more RISs. The UE may prepare the CSI report based at least in part on CSI associated with the one or more reference signals to train the one or more RISs and the one or more reference signals to train the one or more sub-RISs. In other words, the UE may perform measurements of reference signals used for training the RISs and/or sub-RISs, and the UE may report the measurements in the CSI report. The CSI report indicating the CSI may include the measurements of the reference signals used for training the RISs and/or sub-RISs.

In some aspects, the UE may receive, from the network node, an indication of different levels of priority per CSI report or per CSI resource. The indication of different levels of priority may define a first level associated with an aperiodic CSI reporting, a semi-persistent CSI reporting, or a periodic CSI reporting. The indication of different levels of priority may define a second level associated with a beam management CSI reporting or a channel quality indicator CSI reporting. The indication of different levels of priority may define a third level associated with CSI reporting per component carrier. The indication of different levels of priority may define a fourth level associated with CSI reporting per report identifier. The indication of different levels of priority may define a fifth level associated with CSI reporting per RIS identifier. The indication of different levels of priority may define a sixth level associated with CSI reporting per sub-RIS identifier. In other words, new priorities may be defined per CSI report or per CSI resource to distinguish between a legacy CSI report, a RIS CSI report, or a sub-RIS CSI report.

In some aspects, when preparing the CSI report, the UE may bundle CSI starting with a highest priority RIS CSI (e.g., CSI associated with a highest priority RIS as compared to other RISs). The UE may drop lower priority per sub-RIS CSI (e.g., CSI associated with lower priority sub-RISs), depending on an available payload size for the CSI report. In other words, for CSI report bundling across RISs and sub-RISs within one RIS, the UE may start with a high priority RIS CSI, and then start to drop per sub-RIS CSI as needed. In some aspects, when preparing the CSI report, the UE may bundle CSI starting with a highest priority sub-RIS CSI (e.g., CSI associated with a highest priority sub-RIS as compared to other sub-RISs). The UE may combine sub-RIS CSI across RISs. The UE may drop lower priority per RIS CSI (e.g., CSI associated with a lower priority RIS, as compared to other RISs), depending on the available payload size for the CSI report. In other words, for CSI report bundling across RISs and sub-RISs within one RIS, the UE may start with a high priority CSI among sub-RISs of one RIS, combine CSI across RISs, and then drop per RIS CSI as needed.

In some aspects, the CSI report may indicate best beams from each sub-RIS of the one or more sub-RISs and best beams for each RIS of the one or more RISs. The CSI report may indicate worst beams from each sub-RIS of the one or more sub-RISs and worst beams for each RIS of the one or more RISs. The CSI report may indicate best co-phasing vectors used among sub-RISs within a RIS of the one or more RISs, or between RISs of the one or more RISs. The CSI report may indicate a best sub-RIS from each RIS of the one or more RISs and a best co-phasing vector across sub-RISs of the one or more RISs. In some aspects, the CSI report may be associated with a RIS of the one or more RISs. The CSI report may indicate an average CSI across sub-RISs of the RIS, or the CSI report may indicate a per-RIS CSI. In some aspects, the UE may generate multiple CSI reports, where each CSI report may be associated with a CSI report priority. In other words, each of the multiple CSI reports may have their own priority. The CSI report priority may be based at least in part on the priority for each of the one or more RISs and for each of the one or more sub-RISs.

In some aspects, the UE may generate multiple CSI reports, such as a first CSI report and a second CSI report. In some aspects, the first CSI report may be associated with a RIS of the one or more RISs. The second CSI report may also be associated with the RIS. The first CSI report may collide with the second CSI report. The UE, when preparing the CSI report, may multiplex or drop one of the first CSI report or the second CSI report based at least in part on the indication of the priority. In some aspects, the first CSI report may be associated with the RIS, and the second CSI report may be associated with a direct link between the UE and the network node, or the second CSI report may be associated with a sidelink interface of the UE. The UE, when preparing the CSI report, may multiplex or drop one of the first CSI report or the second CSI report based at least in part on the indication of the priority.

In some aspects, the UE may receive, from the network node, a pattern of turn on-off across the one or more sub-RISs of a RIS of the one or more RISs, where the pattern may be associated with a training of the RIS. The pattern may be defined per RIS regarding of the serving UE. The UE may receive the pattern from the network node via L1, layer 2 (L2), or layer 3 (L3) signaling.

As shown by reference number 706, the UE may transmit the CSI report to the network node. The CSI report may indicate the CSI for the one or more RISs and/or the one or more sub-RISs. The CSI may indicate an RSRP, RSRQ, SINR, CQI, and/or channel metric associated with the one or more RISs and/or the one or more sub-RISs, which may be based at least in part on the one or more reference signals. The UE may transmit the CSI report to the network node via one of the RISs of the one or more RISs (e.g., a RIS associated with a best CSI as compared to other RISs).

As indicated above, FIG. 7 is provided as an example. Other examples may differ from what is described with regard to FIG. 7.

In some aspects, a network node (or a controlling UE which is able to control RISs and/or sub-RISs) may transmit, to a UE, an indication regarding a certain priority for each RIS or sub-RIS. For example, the indication may indicate that a certain RIS has a higher priority over another RIS, and/or that a certain sub-RIS within a RIS has a higher priority than another sub-RIS in that RIS. The UE may multiplex or bundle CSI associated with multiple sub-RISs (and potentially multiple RISs) based at least in part on the indication. The UE may prepare a CSI report with the CSI based at least in part on the indication. In other words, the UE computing the CSI may use the indication received from the network node when multiplexing, bundling, and/or dropping CSI for transmission to the network node.

In some aspects, new priorities may be defined per report or per resource to distinguish between a legacy CSI report, a CSI report related to a RIS, and/or a CSI report related to a sub-RIS. A priority scheme having different levels of priority may define a first level, which may be associated with CSI reports that are aperiodic, semi-persistent, or periodic. For example, a CSI report that is aperiodic may have a higher priority than a CSI report that is semi-persistent or periodic. The priority scheme may define a second level, which may be associated with CSI reports that are related to a beam management or a CQI. For example, a CSI report that is related to beam management may have a higher priority than a CSI report that is related to CQI. The priority scheme may define a third level, which may include a component carrier. For example, a CSI report with a higher component carrier number may have a higher priority than a CSI report with a lower component carrier number, or vice versa. The priority scheme may include a fourth level, which may include a report identifier. For example, a CSI report with a higher report identifier may have a higher priority than a CSI report with a lower report identifier, or vice versa. The priority scheme may define a fifth level, which may be a RIS identifier. For example, a CSI report with a higher RIS identifier may have a higher priority than a CSI report with a lower RIS identifier, or vice versa. The priority scheme may define a sixth level, which may be a sub-RIS identifier. For example, a CSI report with a higher sub-RIS identifier may have a higher priority than a CSI report with a lower sub-RIS identifier, or vice versa.

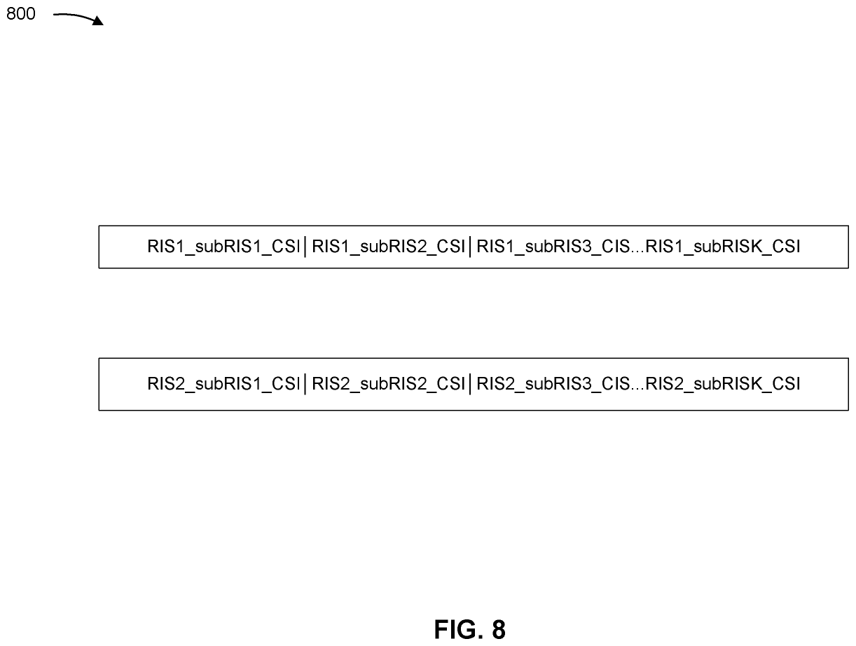

FIG. 8 is a diagram illustrating an example 800 associated with transmitting CSI according to a priority of a RIS, in accordance with the present disclosure.

As shown in FIG. 8, CSI content may include a RIS1 and sub-RIS1 CSI, a RIS1 and sub-RIS2 CSI, a RIS1 and sub-RIS3 CSI, and a RIS1 and sub-RIS-K CSI.

The CSI content may include a RIS2 and sub-RIS1 CSI, a RIS2 and sub-RIS2 CSI, a RIS2 and sub-RIS3 CSI, and a RIS2 and sub-RIS-K CSI. The CSI content may include, for each RIS, CSI associated with each sub-RIS of a particular RIS. The CSI associated with each sub-RIS and for each RIS may be multiplexed or bundled together to form the CSI content, which may be transmitted by a UE to a network node.

As indicated above, FIG. 8 is provided as an example. Other examples may differ from what is described with regard to FIG. 8.

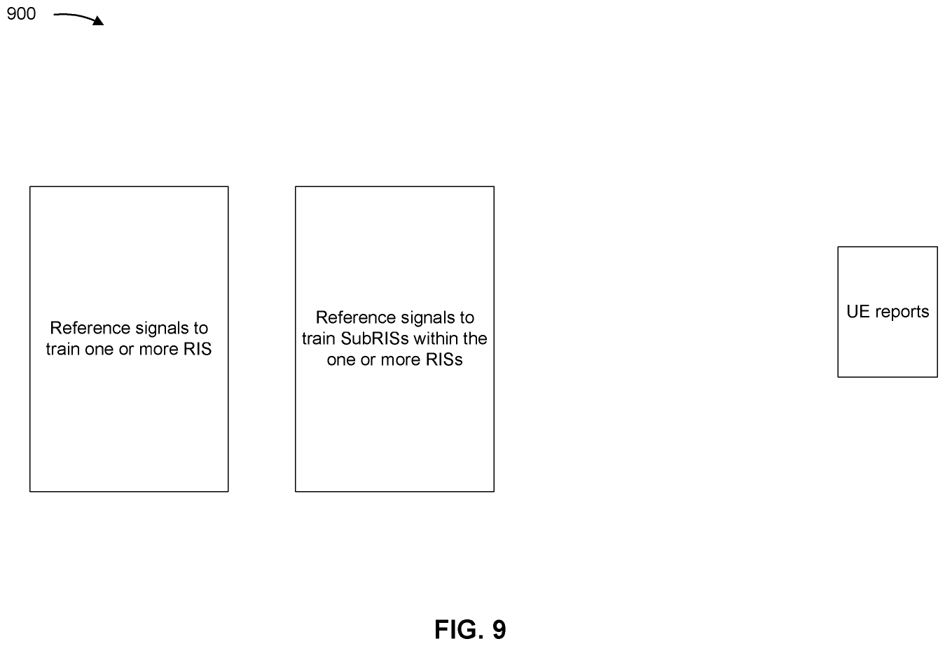

FIG. 9 is a diagram illustrating an example 900 associated with transmitting CSI according to a priority of a RIS, in accordance with the present disclosure.

As shown in FIG. 9, during a training procedure, a network node may transmit one or more reference signals to train one or more RISs and to train one or more sub-RISs within the one or more RISs. The UE may receive, from the network node, the one or more training signals via the one or more RISs and/or via the one or more sub-RISs. The UE may perform measurements associated with the one or more training signals. The UE may transmit, to the network node, a UE report to indicate the measurements. The UE, when preparing the UE report, may multiplex or bundle CSI associated with the one or more RISs and/or the one or more sub-RISs based at least in part on priorities associated with the one or more RISs and/or the one or more sub-RISs.

As indicated above, FIG. 9 is provided as an example. Other examples may differ from what is described with regard to FIG. 9.

In some aspects, a CSI report received from a RIS may indicate an average CSI across a plurality of sub-RISs of the RIS, and/or a per-sub-RIS CSI. The CSI report may indicate the best K beams from each sub-RIS of the RIS, and the best Y beams from each RIS (which may be averaged across a plurality of sub-RISs within the RIS, or with a certain beam training for an entire RIS). The CSI report may indicate the worst E beams from each sub-RIS of the RIS, and the worst F beams from each RIS (which may be averaged across a plurality of sub-RISs within the RIS, or with a certain beam training for an entire RIS). The CSI report may indicate the best co-phasing vectors used among the sub-RISs within the RIS, and/or between RISs. For example, the CSI report may indicate the best Z combinations per RIS and across a plurality of RISs. The CSI report may indicate the best sub-RIS from each RIS and the best co-phasing across those sub-RISs.

In some aspects, different CSI reports may have its own priority. For example, a first CSI report that indicates the best K beams from each sub-RIS of the RIS and the best Y beams from each RIS may have a different priority than a second CSI report that indicates the worst E beams from each sub-RIS of the RIS and the worst F beams from each RIS. When a CSI report is based at least in part on a combination of RISs and sub-RISs, a priority associated with the CSI report may be based at least in part on a highest priority among all of the RISs and sub-RISs, or a new priority may be given for each combination of RISs and sub-RISs. In some aspects, for a CSI report bundling across RISs and across sub-RISs within a RIS, a UE may start with a high priority among the RISs, and then start to drop per-sub-RIS CSI as needed. Alternatively, the UE may start with a high priority among sub-RISs per RIS, and then the UE may combine across RISs, and then drop per-RIS CSI as needed.

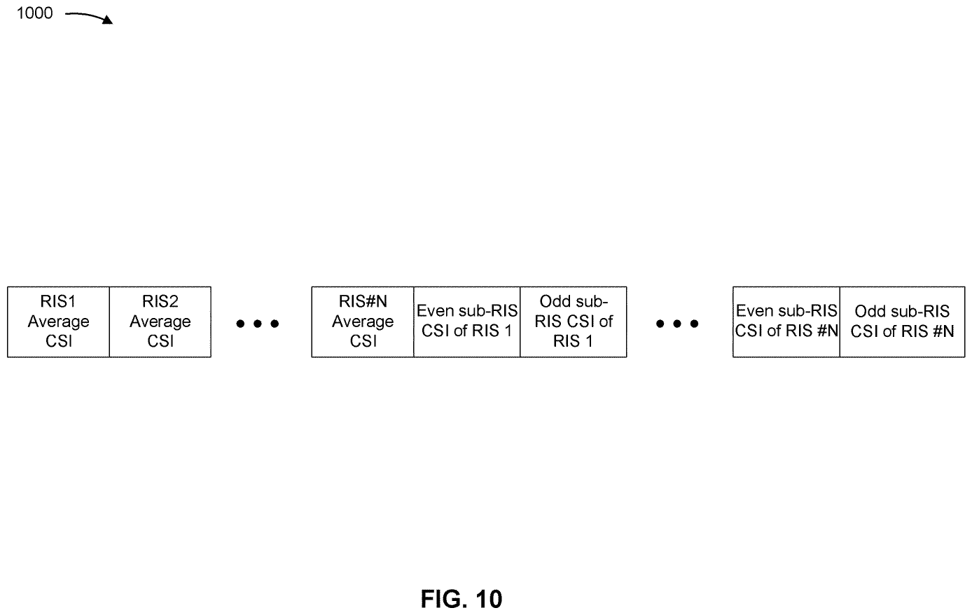

FIG. 10 is a diagram illustrating an example 1000 associated with transmitting CSI according to a priority of a RIS, in accordance with the present disclosure.

As shown in FIG. 10, a CSI report may indicate CSI for a plurality of RISs. For example, the CSI report may indicate an average CSI for RIS1, an average CSI for RIS2, and an average CSI for RIS #N. RIS1 may have the highest priority, RIS2 may have the second highest priority, and so on. The CSI report may then indicate one or more sub-RISs for each RIS. For example, the CSI may indicate an even sub-RIS CSI of RIS1, an odd sub-RIS of RIS1, an even sub-RIS CSI of RIS #N, and an odd sub-RIS CSI of RIS #N. In other words, the CSI report may include CSI for the plurality of RISs, where each RIS in the plurality of RISs may have at least one sub-RIS.

As indicated above, FIG. 10 is provided as an example. Other examples may differ from what is described with regard to FIG. 10.

In some aspects, when a UE is configured with two CSI reports for a particular RIS, and the two CSI reports collide with each other in a PHY layer, the UE may implement multiplexing and dropping rules across the CSI reports from that particular RIS (e.g., an entire CSI report from the RIS). The UE may resolve the collision (or conflict) between the two CSI reports using the highest priority indication of the RIS.

In some aspects, the UE may have a CSI report of its own. The CSI report may be for a direct link between the UE and a network node. The UE may transmit CSI reports from a sidelink to the network node (e.g., a CSI report associated with a sidelink interface of the UE), where at least one of the CSI reports may be a legacy CSI report. The UE may also have CSI reports associated with a RIS and/or sub-RISs associated with the RIS. The UE may multiplex or drop certain CSI reports (e.g., the UE's own CSI report and the CSI reports associated with the RIS and/or the sub-RISs) based at least in part on a priority of each CSI report. After a multiplexing or a dropping, the UE may transmit a CSI report, which may have a type 1 report (e.g., a CSI report for the RIS and/or the sub-RISs) and a legacy CSI report (e.g., a CSI report associated with a wideband and/or subband).

In some aspects, when training a RIS, a pattern of turn on/off across sub-RISs may be used. The pattern may be defined per RIS regardless of serving UE(s). The pattern may be defined per a plurality of RISs (e.g., all RISs) based at least in part on a procedure to split a RIS surface into sub-RISs. A network node or a controlling UE may indicate the pattern to a UE via L1, L2, or L3 signaling.

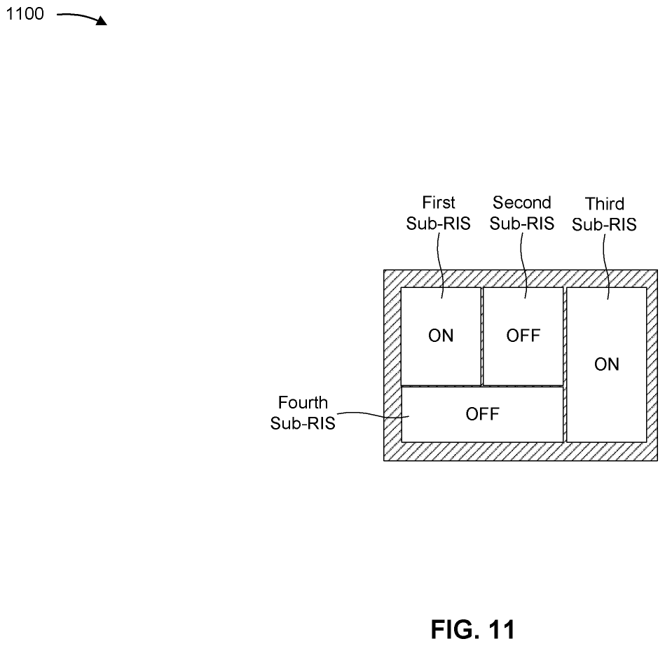

FIG. 11 is a diagram illustrating an example 1100 associated with transmitting CSI according to a priority of a RIS, in accordance with the present disclosure.

As shown in FIG. 11, a pattern may define a turn on/off across sub-RISs of a RIS. The pattern may indicate that a first sub-RIS should be turned on. The pattern may indicate that a second sub-RIS should be turned off. The pattern may indicate that a third sub-RIS should be turned on. The pattern may indicate that a fourth sub-RIS should be turned off. The pattern may be used when training the RIS.

As indicated above, FIG. 11 is provided as an example. Other examples may differ from what is described with regard to FIG. 11.

FIG. 12 is a diagram illustrating an example process 1200 performed, for example, by a UE, in accordance with the present disclosure. Example process 1200 is an example where the UE (e.g., UE 120) performs operations associated with transmitting CSI according to a priority of a RIS.

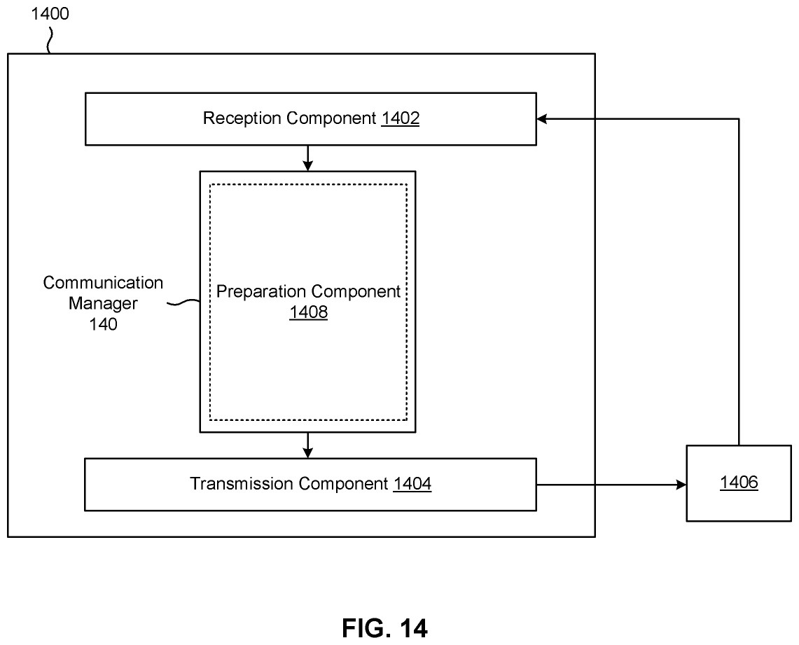

As shown in FIG. 12, in some aspects, process 1200 may include receiving, from a network node or a controlling UE, an indication of a priority for one or more RISs between the UE and the network node, and for one or more sub-RISs of the one or more RISs (block 1210). For example, the UE (e.g., using communication manager 140 and/or reception component 1402, depicted in FIG. 14) may receive, from a network node or a controlling UE, an indication of a priority for one or more RISs between the UE and the network node, and for one or more sub-RISs of the one or more RISs, as described above.

As further shown in FIG. 12, in some aspects, process 1200 may include preparing a CSI report for the one or more RISs and for the one or more sub-RISs based at least in part on the indication of the priority (block 1220). For example, the UE (e.g., using communication manager 140 and/or preparation component 1408, depicted in FIG. 14) may prepare a CSI report for the one or more RISs and for the one or more sub-RISs based at least in part on the indication of the priority, as described above.

As further shown in FIG. 12, in some aspects, process 1200 may include transmitting, to the network node, the CSI report (block 1230). For example, the UE (e.g., using communication manager 140 and/or transmission component 1404, depicted in FIG. 14) may transmit, to the network node, the CSI report, as described above.

Process 1200 may include additional aspects, such as any single aspect or any combination of aspects described below and/or in connection with one or more other processes described elsewhere herein.

In a first aspect, process 1200 includes multiplexing CSI associated with one or more of specific RISs of the one or more RISs or specific sub-RISs of the one or more sub-RISs based at least in part on the indication of the priority.

In a second aspect, alone or in combination with the first aspect, process 1200 includes dropping CSI associated with one or more of specific RISs of the one or more RISs or specific sub-RISs of the one or more sub-RISs based at least in part on the indication of the priority.

In a third aspect, alone or in combination with one or more of the first and second aspects, process 1200 includes receiving, from the network node, an indication of different levels of priority per CSI report or per CSI resource, wherein the indication of different levels of priority defines a first level associated with an aperiodic CSI reporting, a semi-persistent CSI reporting, or a periodic CSI reporting, a second level associated with a beam management CSI reporting or a CQI CSI reporting, a third level associated with CSI reporting per component carrier, a fourth level associated with CSI reporting per report identifier, a fifth level associated with CSI reporting per RIS identifier, and a sixth level associated with CSI reporting per sub-RIS identifier, wherein the CSI report is transmitted based at least in part on the indication of different levels of priority.

In a fourth aspect, alone or in combination with one or more of the first through third aspects, process 1200 includes receiving, from the network node and during a training procedure, one or more reference signals to train the one or more RISs, and receiving, from the network node and during the training procedure, one or more reference signals to train the one or more sub-RISs of the one or more RISs, wherein the CSI report is prepared based at least in part on CSI associated with the one or more reference signals to train the one or more RISs and the one or more reference signals to train the one or more sub-RISs.

In a fifth aspect, alone or in combination with one or more of the first through fourth aspects, the CSI report is associated with a RIS of the one or more RISs, and the CSI report indicates an average CSI across sub-RISs of the RIS, or the CSI report indicates a per-RIS CSI.

In a sixth aspect, alone or in combination with one or more of the first through fifth aspects, the CSI report indicates one of best beams from each sub-RIS of the one or more sub-RISs and best beams for each RIS of the one or more RISs, worst beams from each sub-RIS of the one or more sub-RISs and worst beams for each RIS of the one or more RISs, best co-phasing vectors used among sub-RISs within a RIS of the one or more RISs, or between RISs of the one or more RISs, or a best sub-RIS from each RIS of the one or more RISs and a best co-phasing vector across sub-RISs of the one or more RISs.

In a seventh aspect, alone or in combination with one or more of the first through sixth aspects, the CSI report is associated with a CSI report priority, and the CSI report priority is based at least in part on the priority for each of the one or more RISs and for each of the one or more sub-RISs.

In an eighth aspect, alone or in combination with one or more of the first through seventh aspects, process 1200 includes bundling CSI starting with a highest priority RIS CSI, and dropping lower priority per sub-RIS CSI.

In a ninth aspect, alone or in combination with one or more of the first through eighth aspects, process 1200 includes bundling CSI starting with a highest priority sub-RIS CSI, combining sub-RIS CSI across RISs, and dropping lower priority per RIS CSI.

In a tenth aspect, alone or in combination with one or more of the first through ninth aspects, the CSI report is a first CSI report associated with a RIS of the one or more RISs, wherein the first CSI report collides with a second CSI report associated with the RIS, and process 1200 includes multiplexing or dropping one of the first CSI report or the second CSI report based at least in part on the indication of the priority.

In an eleventh aspect, alone or in combination with one or more of the first through tenth aspects, the CSI is a first CSI report associated with a RIS of the one or more RISs, wherein a second CSI report is associated with a direct link between the UE and the network node or the second CSI report is associated with a sidelink interface of the UE, and process 1200 includes multiplexing or dropping one of the first CSI report or the second CSI report based at least in part on the indication of the priority.

In a twelfth aspect, alone or in combination with one or more of the first through eleventh aspects, process 1200 includes receiving, from the network node, a pattern of turn on-off across the one or more sub-RISs of a RIS of the one or more RISs, wherein the pattern is associated with a training of the RIS.

In a thirteenth aspect, alone or in combination with one or more of the first through twelfth aspects, the pattern is defined per RIS regardless of serving UEs, and wherein the pattern is received via L1, L2, or L3 signaling from the network node.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network node, in accordance with the present disclosure. Example process 1300 is an example where the network node (e.g., network node 110) performs operations associated with transmitting CSI according to a priority of a RIS.

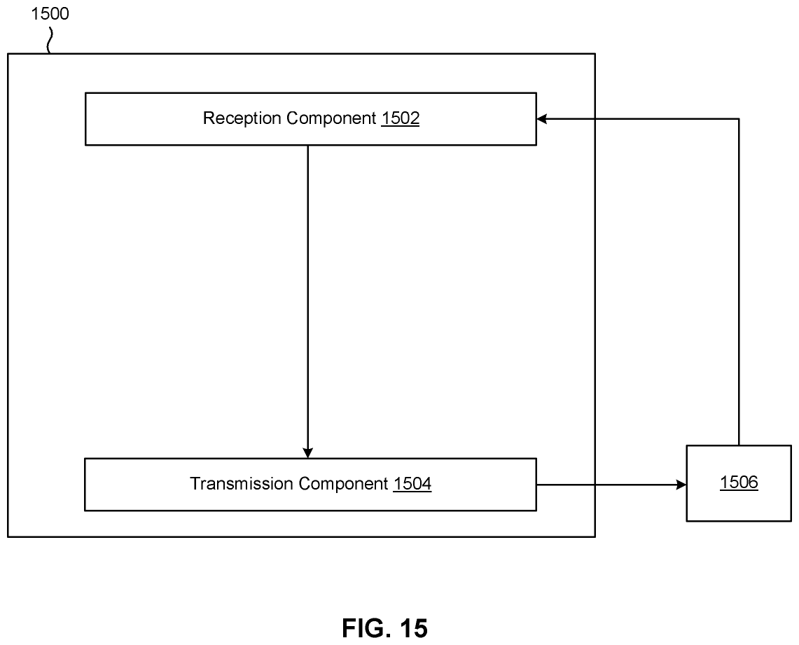

As shown in FIG. 13, in some aspects, process 1300 may include transmitting, to a UE, an indication of a priority for one or more RISs between the UE and the network node, and for one or more sub-RISs of the one or more RISs (block 1310). For example, the network node (e.g., using transmission component 1504, depicted in FIG. 15) may transmit, to a UE, an indication of a priority for one or more RISs between the UE and the network node, and for one or more sub-RISs of the one or more RISs, as described above.

As further shown in FIG. 13, in some aspects, process 1300 may include receiving, from the UE, a CSI report for the one or RISs and for the one or more sub-RISs, wherein the CSI report is prepared based at least in part on the indication of the priority (block 1320). For example, the network node (e.g., using reception component 1502, depicted in FIG. 15) may receive, from the UE, a CSI report for the one or RISs and for the one or more sub-RISs, wherein the CSI report is prepared based at least in part on the indication of the priority, as described above.

Process 1300 may include additional aspects, such as any single aspect or any combination of aspects described below and/or in connection with one or more other processes described elsewhere herein.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 140. The communication manager 140 may include a preparation component 1408, among other examples.

In some aspects, the apparatus 1400 may be configured to perform one or more operations described herein in connection with FIGS. 7-11. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The reception component 1402 may receive, from a network node or a controlling UE, an indication of a priority for one or more RISs between the UE and the network node, and for one or more sub-RISs of the one or more RISs. The preparation component 1408 may prepare a CSI report for the one or more RISs and for the one or more sub-RISs based at least in part on the indication of the priority. The transmission component 1404 may transmit, to the network node, the CSI report.

The preparation component 1408 may multiplex CSI associated with one or more of: specific RISs of the one or more RISs or specific sub-RISs of the one or more sub-RISs based at least in part on the indication of the priority. The preparation component 1408 may drop CSI associated with one or more of: specific RISs of the one or more RISs or specific sub-RISs of the one or more sub-RISs based at least in part on the indication of the priority.

The reception component 1402 may receive, from the network node, an indication of different levels of priority per CSI report or per CSI resource. The transmission component 1404 may transmit the CSI report based at least in part on the indication of different levels of priority. The reception component 1402 may receive, from the network node and during a training procedure, one or more reference signals to train the one or more RISs. The reception component 1402 may receive, from the network node and during the training procedure, one or more reference signals to train the one or more sub-RISs of the one or more RISs. The preparation component 1408 may prepare the CSI report based at least in part on CSI associated with the one or more reference signals to train the one or more RISs and the one or more reference signals to train the one or more sub-RISs.

The preparation component 1408 may bundle CSI starting with a highest priority RIS CSI. The preparation component 1408 may drop lower priority per sub-RIS CSI. The preparation component 1408 may bundle CSI starting with a highest priority sub-RIS CSI. The preparation component 1408 may combine sub-RIS CSI across RISs. The preparation component 1408 may drop lower priority per RIS CSI.

The reception component 1402 may receive, from the network node, a pattern of turn on-off across the one or more sub-RISs of a RIS of the one or more RISs, wherein the pattern is associated with a training of the RIS.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504.

In some aspects, the apparatus 1500 may be configured to perform one or more operations described herein in connection with FIGS. 7-11. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

The transmission component 1504 may transmit, to a UE, an indication of a priority for one or more RISs between the UE and the network node, and for one or more sub-RISs of the one or more RISs. The reception component 1502 may receive, from the UE, a CSI report for the one or RISs and for the one or more sub-RISs, wherein the CSI report is prepared based at least in part on the indication of the priority.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving, from a network node or a controlling UE, an indication of a priority for one or more reconfigurable intelligent surfaces (RISs) between the UE and the network node, and for one or more sub-RISs of the one or more RISs; preparing a channel state information (CSI) report for the one or more RISs and for the one or more sub-RISs based at least in part on the indication of the priority; and transmitting, to the network node, the CSI report.

Aspect 2: The method of Aspect 1, wherein preparing the CSI report comprises: multiplexing CSI associated with one or more of: specific RISs of the one or more RISs or specific sub-RISs of the one or more sub-RISs based at least in part on the indication of the priority.

Aspect 3: The method of any of Aspects 1 through 2, wherein preparing the CSI report comprises: dropping CSI associated with one or more of: specific RISs of the one or more RISs or specific sub-RISs of the one or more sub-RISs based at least in part on the indication of the priority.
Aspect 4: The method of any of Aspects 1 through 3, further comprising: receiving, from the network node, an indication of different levels of priority per CSI report or per CSI resource, wherein the indication of different levels of priority defines: a first level associated with an aperiodic CSI reporting, a semi-persistent CSI reporting, or a periodic CSI reporting; a second level associated with a beam management CSI reporting or a channel quality indicator CSI reporting; a third level associated with CSI reporting per component carrier; a fourth level associated with CSI reporting per report identifier; a fifth level associated with CSI reporting per RIS identifier; and a sixth level associated with CSI reporting per sub-RIS identifier, wherein the CSI report is transmitted based at least in part on the indication of different levels of priority.

Aspect 5: The method of any of Aspects 1 through 4, further comprising: receiving, from the network node and during a training procedure, one or more reference signals to train the one or more RISs; and receiving, from the network node and during the training procedure, one or more reference signals to train the one or more sub-RISs of the one or more RISs, wherein the CSI report is prepared based at least in part on CSI associated with the one or more reference signals to train the one or more RISs and the one or more reference signals to train the one or more sub-RISs.

Aspect 6: The method of any of Aspects 1 through 5, wherein the CSI report is associated with a RIS of the one or more RISs, and wherein the CSI report indicates an average CSI across sub-RISs of the RIS, or the CSI report indicates a per-RIS CSI.

Aspect 7: The method of any of Aspects 1 through 6, wherein the CSI report indicates one of: best beams from each sub-RIS of the one or more sub-RISs and best beams for each RIS of the one or more RISs; worst beams from each sub-RIS of the one or more sub-RISs and worst beams for each RIS of the one or more RISs; best co-phasing vectors used among sub-RISs within a RIS of the one or more RISs, or between RISs of the one or more RISs; or a best sub-RIS from each RIS of the one or more RISs and a best co-phasing vector across sub-RISs of the one or more RISs.

Aspect 8: The method of any of Aspects 1 through 7, wherein the CSI report is associated with a CSI report priority, and wherein the CSI report priority is based at least in part on the priority for each of the one or more RISs and for each of the one or more sub-RISs.

Aspect 9: The method of any of Aspects 1 through 8, wherein preparing the CSI report comprises: bundling CSI starting with a highest priority RIS CSI; and dropping lower priority per sub-RIS CSI.

Aspect 10: The method of any of Aspects 1 through 9, wherein preparing the CSI report comprises: bundling CSI starting with a highest priority sub-RIS CSI; combining sub-RIS CSI across RISs; and dropping lower priority per RIS CSI.

Aspect 11: The method of any of Aspects 1 through 10, wherein the CSI report is a first CSI report associated with a RIS of the one or more RISs, wherein the first CSI report collides with a second CSI report associated with the RIS, and wherein preparing the CSI report comprises: multiplexing or dropping one of the first CSI report or the second CSI report based at least in part on the indication of the priority.

Aspect 12: The method of any of Aspects 1 through 11, wherein the CSI is a first CSI report associated with a RIS of the one or more RISs, wherein a second CSI report is associated with a direct link between the UE and the network node or the second CSI report is associated with a sidelink interface of the UE, and wherein preparing the CSI report comprises: multiplexing or dropping one of the first CSI report or the second CSI report based at least in part on the indication of the priority.

Aspect 13: The method of any of Aspects 1 through 12, further comprising: receiving, from the network node, a pattern of turn on-off across the one or more sub-RISs of a RIS of the one or more RISs, wherein the pattern is associated with a training of the RIS.

Aspect 14: The method of Aspect 13, wherein the pattern is defined per RIS regardless of serving UEs, and wherein the pattern is received via layer 1, layer 2, or layer 3 signaling from the network node.

Aspect 15: A method of wireless communication performed by a network node, comprising: transmitting, to a user equipment (UE), an indication of a priority for one or more reconfigurable intelligent surfaces (RISs) between the UE and the network node, and for one or more sub-RISs of the one or more RISs; and receiving, from the UE, a channel state information (CSI) report for the one or RISs and for the one or more sub-RISs, wherein the CSI report is prepared based at least in part on the indication of the priority.

Aspect 16: An apparatus for wireless communication at a device, comprising a processor; memory coupled with the processor; and instructions stored in the memory and executable by the processor to cause the apparatus to perform the method of one or more of Aspects 1-14.

Aspect 17: A device for wireless communication, comprising a memory and one or more processors coupled to the memory, the one or more processors configured to perform the method of one or more of Aspects 1-14.

Aspect 18: An apparatus for wireless communication, comprising at least one means for performing the method of one or more of Aspects 1-14.

Aspect 19: A non-transitory computer-readable medium storing code for wireless communication, the code comprising instructions executable by a processor to perform the method of one or more of Aspects 1-14.

Aspect 20: A non-transitory computer-readable medium storing a set of instructions for wireless communication, the set of instructions comprising one or more instructions that, when executed by one or more processors of a device, cause the device to perform the method of one or more of Aspects 1-14.

Aspect 21: An apparatus for wireless communication at a device, comprising a processor; memory coupled with the processor; and instructions stored in the memory and executable by the processor to cause the apparatus to perform the method of Aspect 14.

Aspect 22: A device for wireless communication, comprising a memory and one or more processors coupled to the memory, the one or more processors configured to perform the method of Aspect 14.

Aspect 23: An apparatus for wireless communication, comprising at least one means for performing the method of Aspect 14.

Aspect 24: A non-transitory computer-readable medium storing code for wireless communication, the code comprising instructions executable by a processor to perform the method of Aspect 14.

Aspect 25: A non-transitory computer-readable medium storing a set of instructions for wireless communication, the set of instructions comprising one or more instructions that, when executed by one or more processors of a device, cause the device to perform the method of Aspect 14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, andc+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) comprising:
a memory; and
one or more processors, coupled to the memory, configured to:
receive, from a network node or a controlling UE, an indication of a priority for one or more reconfigurable intelligent surfaces (RISs) between the UE and the network node, and for one or more sub-RISs of the one or more RISs;
prepare a channel state information (CSI) report for the one or more RISs and for the one or more sub-RISs based at least in part on the indication of the priority; and
transmit, to the network node, the CSI report.

2. The UE of claim 1, wherein the one or more processors, to prepare the CSI report, are configured to:
multiplex CSI associated with one or more of: specific RISs of the one or more RISs or specific sub-RISs of the one or more sub-RISs based at least in part on the indication of the priority.

3. The UE of claim 1, wherein the one or more processors, to prepare the CSI report, are configured to:
drop CSI associated with one or more of: specific RISs of the one or more RISs or specific sub-RISs of the one or more sub-RISs based at least in part on the indication of the priority.

4. The UE of claim 1, wherein the one or more processors are further configured to:
receive, from the network node, an indication of different levels of priority per CSI report or per CSI resource, wherein the indication of different levels of priority defines:
a first level associated with an aperiodic CSI reporting, a semi-persistent CSI reporting, or a periodic CSI reporting;
a second level associated with a beam management CSI reporting or a channel quality indicator CSI reporting;
a third level associated with CSI reporting per component carrier;
a fourth level associated with CSI reporting per report identifier;
a fifth level associated with CSI reporting per RIS identifier; and
a sixth level associated with CSI reporting per sub-RIS identifier,
wherein the CSI report is transmitted based at least in part on the indication of different levels of priority.

5. The UE of claim 1, wherein the one or more processors are further configured to:
receive, from the network node and during a training procedure, one or more reference signals to train the one or more RISs; and
receive, from the network node and during the training procedure, one or more reference signals to train the one or more sub-RISs of the one or more RISs,
wherein the CSI report is prepared based at least in part on CSI associated with the one or more reference signals to train the one or more RISs and the one or more reference signals to train the one or more sub-RISs.

6. The UE of claim 1, wherein the CSI report is associated with a RIS of the one or more RISs, and wherein the CSI report indicates an average CSI across sub-RISs of the RIS, or the CSI report indicates a per-RIS CSI.

7. The UE of claim 1, wherein the CSI report indicates one of:
best beams from each sub-RIS of the one or more sub-RISs and best beams for each RIS of the one or more RISs;
worst beams from each sub-RIS of the one or more sub-RISs and worst beams for each RIS of the one or more RISs;
best co-phasing vectors used among sub-RISs within a RIS of the one or more RISs, or between RISs of the one or more RISs; or
a best sub-RIS from each RIS of the one or more RISs and a best co-phasing vector across sub-RISs of the one or more RISs.

8. The UE of claim 1, wherein the CSI report is associated with a CSI report priority, and wherein the CSI report priority is based at least in part on the priority for each of the one or more RISs and for each of the one or more sub-RISs.

9. The UE of claim 1, wherein the one or more processors, to prepare the CSI report, are configured to:
bundle CSI starting with a highest priority RIS CSI; and
drop lower priority per sub-RIS CSI.

10. The UE of claim 1, wherein the one or more processors, to prepare the CSI report, are configured to:
bundle CSI starting with a highest priority sub-RIS CSI;
combine sub-RIS CSI across RISs; and
drop lower priority per RIS CSI.

11. The UE of claim 1, wherein the CSI report is a first CSI report associated with a RIS of the one or more RISs, wherein the first CSI report collides with a second CSI report associated with the RIS, and wherein the one or more processors, to prepare the CSI report, are configured to:
multiplex or drop one of the first CSI report or the second CSI report based at least in part on the indication of the priority.

12. The UE of claim 1, wherein the CSI is a first CSI report associated with a RIS of the one or more RISs, wherein a second CSI report is associated with a direct link between the UE and the network node or the second CSI report is associated with a sidelink interface of the UE, and wherein the one or more processors, to prepare the CSI report, are configured to:
multiplex or drop one of the first CSI report or the second CSI report based at least in part on the indication of the priority.

13. The UE of claim 1, wherein the one or more processors are further configured to:
receive, from the network node, a pattern of turn on-off across the one or more sub-RISs of a RIS of the one or more RISs, wherein the pattern is associated with a training of the RIS.

14. The UE of claim 13, wherein the pattern is defined per RIS regardless of serving UEs, and wherein the pattern is received via layer 1, layer 2, or layer 3 signaling from the network node.

15. A network node comprising:
a memory; and
one or more processors, coupled to the memory, configured to:
transmit, to a user equipment (UE), an indication of a priority for one or more reconfigurable intelligent surfaces (RISs) between the UE and the network node, and for one or more sub-RISs of the one or more RISs; and
receive, from the UE, a channel state information (CSI) report for the one or RISs and for the one or more sub-RISs, wherein the CSI report is prepared based at least in part on the indication of the priority.

16. A method of wireless communication performed by a user equipment (UE), comprising:
receiving, from a network node or a controlling UE, an indication of a priority for one or more reconfigurable intelligent surfaces (RISs) between the UE and the network node, and for one or more sub-RISs of the one or more RISs;
preparing a channel state information (CSI) report for the one or more RISs and for the one or more sub-RISs based at least in part on the indication of the priority; and
transmitting, to the network node, the CSI report.

17. The method of claim 16, wherein preparing the CSI report comprises:
multiplexing CSI associated with one or more of: specific RISs of the one or more RISs or specific sub-RISs of the one or more sub-RISs based at least in part on the indication of the priority.

18. The method of claim 16, wherein preparing the CSI report comprises:
dropping CSI associated with one or more of: specific RISs of the one or more RISs or specific sub-RISs of the one or more sub-RISs based at least in part on the indication of the priority.

19. The method of claim 16, further comprising:
receiving, from the network node, an indication of different levels of priority per CSI report or per CSI resource, wherein the indication of different levels of priority defines:
a first level associated with an aperiodic CSI reporting, a semi-persistent CSI reporting, or a periodic CSI reporting;
a second level associated with a beam management CSI reporting or a channel quality indicator CSI reporting;
a third level associated with CSI reporting per component carrier;
a fourth level associated with CSI reporting per report identifier;
a fifth level associated with CSI reporting per RIS identifier; and
a sixth level associated with CSI reporting per sub-RIS identifier,
wherein the CSI report is transmitted based at least in part on the indication of different levels of priority.

20. The method of claim 16, further comprising:
receiving, from the network node and during a training procedure, one or more reference signals to train the one or more RISs; and
receiving, from the network node and during the training procedure, one or more reference signals to train the one or more sub-RISs of the one or more RISs,
wherein the CSI report is prepared based at least in part on CSI associated with the one or more reference signals to train the one or more RISs and the one or more reference signals to train the one or more sub-RISs.

21-30. (canceled)
